(19) United States
(12) Patent Application Publication
(10) Pub. No.: US 2025/0100176 A1
(43) Pub. Date: Mar. 27, 2025

(54) APPARATUS FOR TAPER CUTTING SQUARE WORKPIECES FOR USE AS VERTICAL SUPPORTS AND OTHER APPLICATIONS.

(71) Applicants: Paul Anthony Coartney, San Diego, CA (US); Preston Coartney, San Diego, CA (US)

(72) Inventors: Paul Anthony Coartney, San Diego, CA (US); Preston Coartney, San Diego, CA (US)

(21) Appl. No.: 18/473,906

(22) Filed: Sep. 25, 2023

(51) Int. Cl. B27B 27/08

(52) U.S. Cl. CPC B27B 27/08

(57) ABSTRACT

The invention is a taper jig that provides a significant improvement of previous art by using pins and horizontal clamping to secure the workpiece. It is ideally suited for tapering square and rectangular workpieces for table and chair legs. The use of pins in the hold-downs into the workpiece enable the user to more safely hold the workpiece while tapering up to all four of the longitudinal sides. The use of horizontal clamping pressure enables a workpiece at or near the full capacity of the saw to be tapered. While all researched taper jigs use some variation of Carter's jig to provide the angle of taper, this invention improves on those designs in the manner the workpiece is secured.

### CROSS-REFERENCE TO RELATED APPLICATIONS

U.S. Pat. No. 2,032,976 Adjustable Taper Ripping Jig, R. L. Carter
2014/0208912 Tapering Jig for a Woodworking Apparatus, H. Wang
2011/0067541 Apparatus for Conveying a Workpiece to Make a Straight-Line Cut, C. Potter
2023/0037039 A1 Taper Jig and Methods of Use, Duxbury 2 Feb. 2023.

### FEDERALLY SPONSORED RESEARCH AND DEVELOPMENT

Not Applicable

### JOINT RESEARCH AGREEMENT

This invention was developed by Paul A. Coartney and Preston R. Coartney, Citizens of the United States of American residing in California.

### REFERENCE TO A “SEQUENCE LISTING”, A TABLE, OR A COMPUTER PROGRAM LISTING APPENDIX SUBMITTTED ON A COMPACT DISC AND AN INCORPORATION-BY-REFERENCE OF THE MATERIAL ON THE COMPACT DISC

Not Applicable

### BACKGROUND OF THE INVENTION

This invention relates generally to the field of woodworking and more particularly to the field of accessories for setting and angle at which the stock material, workpiece, is presented for cutting.

This invention came out of the need to safely and securely hold a workpiece while making a straight line cut on a table, band or similar saw, heretofore referred to as the machine, at or near the fully extend height of the blade, i.e. the maximum depth of cut. In order to achieve cuts at or near the full height and subsequently height less than full extension the workpiece must rest on the machines native surface. The uniqueness of this tool is the ability to hold the workpiece by horizontal clamping force aided by pins protruding into the workpiece and to make a straight line cut on four of the six surfaces, the longitudinal faces, of a rectangular workpiece. Like Carter, it uses two bases that pivot at various angles allowing for a straight-line cut up to a maximum angle but improves on Carter's design by securely holding the workpiece with two hold-downs with pins. The hold-downs provide the ability to apply horizontal clamping pressure while the pins secure the workpiece in a fixed position. Previous art by Potter employs hold-downs that provide clamping force vertically. To apply a vertical clamping force, one has to rely on a base the rides on the saw table and supports. This design significantly improves on previous art by securing to the base while allowing for the maximum depth of cut and for all longitudinal surfaces to be cut. Both Carter and Wang rely on a small perpendicular protrusion to push the workpiece through the blade but do not positively hold the workpiece in place.

To varying degrees, prior art has taken on many different configurations to address these needs. The current set of known configurations appear to rely on limiting the cut depth to the maximum blade height minus a “sled” upon which the workpiece rides and which sits on top of the saw table surface between the workpiece and the machine. The sled limits the usable cut depth by its thickness. Given the nature and function of this invention, it is necessary to examine the prior art that encompasses tapper cutting, strait-line cutting and the means of how these were achieved.

Most recently, Woodpecker's was awarded patent 2023/0037039 A1 Taper Jig and Methods of Use, Duxbury 2 Feb. 2023. This jig leverages the work done by Carter in U.S. Pat. No. 2,032,976 and extends the functionality with additional features, but still relies upon a sled base, therefore limiting workpiece size. Moreover, while it is possible to cut two of the longitudinal faces without issue, cutting the last two pose a significant challenge in securing the piece or repeating the cut accurately and safely.

U.S. Pat. No. 2,032,976 Adjustable Taper Ripping Jig, R. L. Carter. This jig is comprised of two arms hinged at one end with adjustable locking mechanism on the other. The arm that guides the workpiece has an adjustable end stop. The jig is used in conjunction with the rip fence, a standard accessory on table saws and many band saws, which is parallel to the cutting blade and able to be adjusted with regard to distance from the blade. Many variations of this taper jig are available in the marketplace and its utility and value have lasted the test of time. However, there are limitations. The user must manually hold the workpiece in place and with regards to cutting greater than two faces on the same workpiece, the operator is often required to put themselves in close proximity to the operating blade which can be dangerous. Moreover, since the workpiece is being pushed into the blade from the end of the workpiece being tapered, cutting the third and fourth faces of a symmetrically tapered vertical support, table or chair leg for example, is often not possible.

There are other variations of straight-line cutting jigs, some like Carter rely on the preexistence of a parallel rip fence or of a machined slot in the saw table. While some can be used for taper and are aimed at that, others such as patent 2011/0067541 A1 by Potter, are designed primarily to mill a straight edge on a natural or live edge.

Patent 2014/0208912 A1 Tapering Jig for a Woodworking Apparatus by Wang comes closest in function to this invention. Wangs design has the workpiece sit directly on top of the saw table but fails to provide a secure way the hold the workpiece while milling the faces of the workpiece beyond the second. It suffers from the same limitations as Carter but adds much more functionality for setting the taper and making repeatable cuts.

While there are similarities between this invention and others, notably Carter, the significant improvements in securing the workpiece providing increased safety, stability and repeated accuracy are not present in the previous art.

### SUMMARY OF THE INVENTION

This invention provides unique improvements in the way it secures the workpiece enabling the user to taper all longitudinal faces of the workpiece. Like Wang and Duxbury, this invention builds on the basic taper jig design of Carter but has unique enhancements to secure the workpiece by clamping it longitudinally/horizontally and allowing the workpiece to rest on the table of the saw maximizing the depth of cut. This design enables for the milling at the maximum extension of the blade for a circular table saw and allows for the milling of all four longitudinal surfaces of the workpiece. This is accomplished by relying on a horizontal clamping force and further securing the workpiece through the use of pins protruding into the workpiece. These design characteristics are not found in any previous art for taper jigs.

### BRIEF DESCRIPTION OF DRAWINGS

FIG. 1. Overview of tool. The view shows the tool in the closed, zero degrees of taper, position with a workpiece clamped into position.

FIG. 2. Tool without workpiece. This view shows the tool without a workpiece and highlight the pins in the base that protrude into the workpiece.

FIG. 3. Closeup of hold-down, hold-down base elements, workpiece pin and fasteners.

FIG. 4. Hold-down with workpiece pin and fasteners but without base elements.

FIG. 5. Base elements.

FIG. 6. Hold-down with base elements, workpiece pin and T-track.

FIG. 7. Profile view depicting how the hold-downs are secured to the base elements.

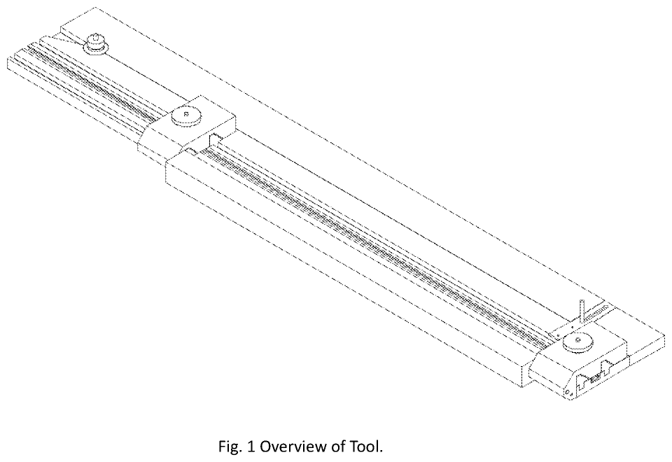

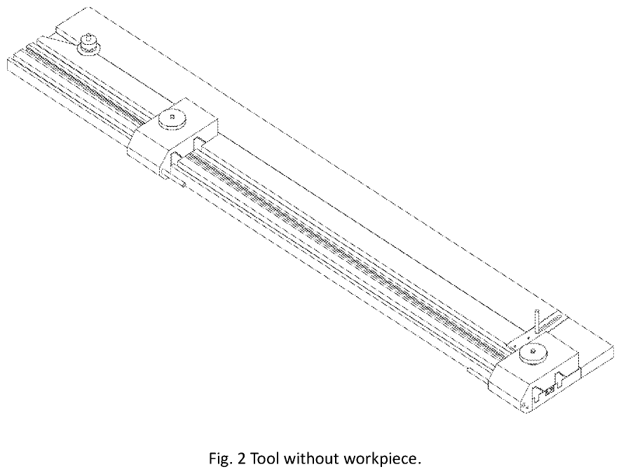

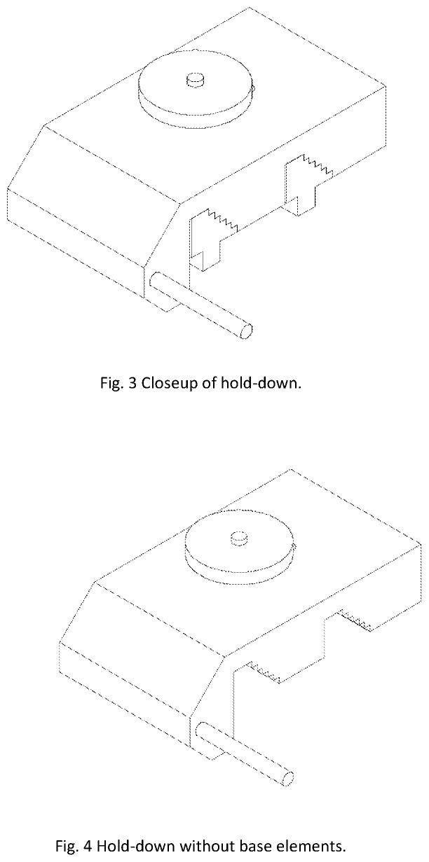

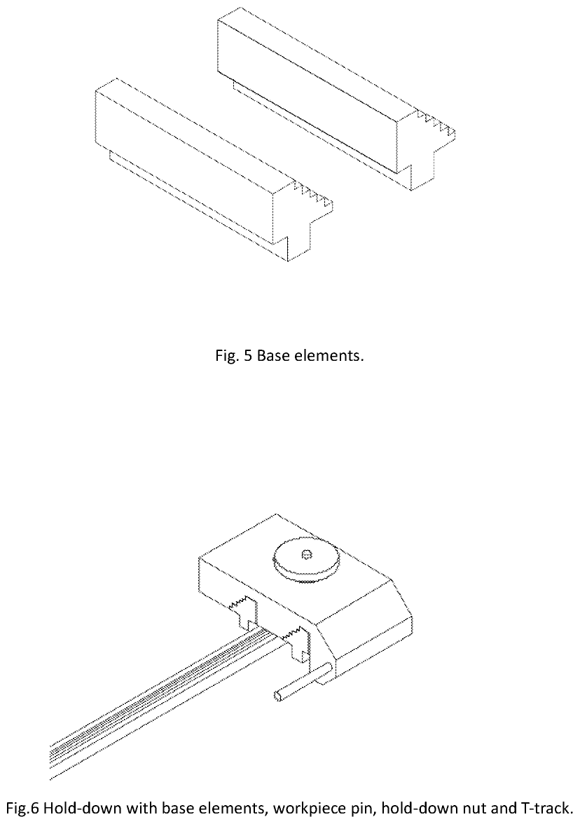

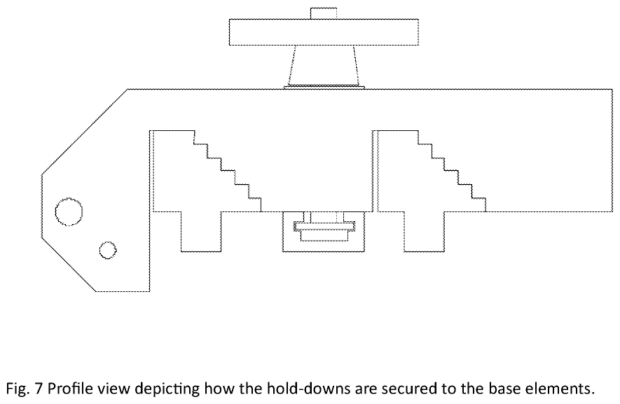

### DETAILED DESCRIPTION OF THE INVENTION

The invention is made up of a two-part base that is attached at one end with a bolt fixing the two halves but allowing it to pivot centered on the bolt. At the other end of the base there is a gage affixed to one side with mechanical fasteners that can be locked at varying degrees of taper on the other half of the base by means of another bolt, washer and nut. One half of the base has three parallel slots (dados) cut into the top surface to allow the workpiece hold-downs to slide longitudinally along the length of the tool and securely hold the workpiece. Two of the slots provide stability for the hold-downs while the third contains a track with T-Bolts that extend from the track through the hold-downs to secure the hold-downs in place and subsequentially hold the workpiece in place. The base is similar in operation and use to all other taper jigs with the functionality first proposed by Carter. The significant improvement for this jig is the hold-downs and the manner they work by providing a horizontal clamping force with pins protruding into the workpiece. The hold-downs are designed to hold the workpiece by clamping it longitudinally and by means of a pin the protrudes from the hold-downs into the workpiece on the lateral ends in the center of the workpiece. The hold-downs are comprised of three main parts, two hold-down bases and the hold-down fixture. The hold-down fixture sits atop the hold-down bases and can be adjusted up and outward of the base to accommodate different size workpieces. The hold-down fixture is locked in place by means of a bolt that projects from the track in the base through the hold-down fixture and is secured with a washer and nut.

To use the invention, holes are drilled in the center of the edge of the workpiece on the ends perpendicular to the faces to be tapered. The center is located by drawing lines across the diagonal from corner to corner on the workpiece. The holes would then be drilled parallel to the longitudinal axis of the workpiece to a depth sufficient for a full insertion of the hold-down pin into the workpiece so the workpiece face with the hole contact the hold-down. The hold-downs are adjusted so the holes in the workpiece and the pins in the hold-downs are aligned and the pins are inserted into the workpiece. The two hold downs are then slid together to clamp the workpiece securely. The taper angle is then set by loosening the pivot nut and sliding the two parts of the base apart to achieve the desired angle. Once this is done, the pivot nut and the nut on the scale are tightened to lock the taper angle. The taper can then be cut on the face away from the jig base. To repeat cuts with the same angle of taper on subsequent longitudinal faces, the workpiece is rotated by loosening the nut securing one of the hold-downs, the loosened hold-down is then slid apart from the workpiece and the workpiece is rotated along the longitudinal axis so the face to be cut is in the correct position. For accuracy and repeatability, the same hold-down should be loosened, the workpiece rotated, and the hold-down tightened for each face cut.

What is claimed is:

1. A tapering jig comprised of two-part base mechanically attached at a pivot point on one end and a scale quantifying taper angle at the other.

2. On top of these two bases are two adjustable hold-down assemblies which can move along the base and provide horizontal clamping force and pins into the workpiece to secure it in place.

3. The hold-down assemblies are comprised of the hold-downs, hold-down bases, securing hardware and pins.

4. The horizontal clamping and pins allow the workpiece to rest on the saw table enabling the full depth of cut of the saw to be used.

5. The hold-downs and the use of horizontal clamping secure the workpiece enabling all four longitudinal sides of the workpiece to be tapered.

6. The tapering jib embodied by these claims is a significant improvement over previous art as it allows for:
a. Workpieces to be tapered at the full depth of cut, height the blade protrudes above the saw table or maximum cut height on a band type saw
b. The pins protruding from the hold-downs and the horizontal clamping force which can be applied in and onto the workpiece help to secure the workpiece to the jig, making for a safer operation and enabling the tapering of all four longitudinal faces of the workpiece
c. The adjustability of the hold-downs allows stock of various sizes to be cut.
